(19) United States
(12) Patent Application Publication
(10) Pub. No.: US 2010/0125537 A1
(43) Pub. Date: May 20, 2010

(54) SYSTEM AND METHOD FOR PROVIDING INSURANCE

(76) Inventor: John L. Baeke, Overland Park, KS (US)

Correspondence Address: ERICKSON, KERNELL, DERUSSEAU & KLEYPAS, LLC, 800 W. 47TH STREET, SUITE 401, KANSAS CITY, MO, 64112, US

(21) Appl. No.: 12/622,319

(22) Filed: Nov. 19, 2009

Related U.S. Application Data
(60) Provisional application No. 61/116,350, filed on Nov. 20, 2008.

(51) Int. Cl. G06Q 90/00

(52) U.S. Cl. 705/500

(57) ABSTRACT

A system and method for providing medical insurance for post-operative events is disclosed which includes underwriting an insurance policy for a medical procedure; offering said insurance policy to a patient undergoing said medical procedure; receiving an application for said insurance policy from said patient; approving said application for said insurance policy from said patient; performing said medical procedure on said patient; receiving a policy claim for an event; evaluating said policy claim to determine if said event is a covered event; denying said policy claim if said event is not a covered event or if said policy has expired; and if said event is a covered event, recommending a treatment; treating said patient by a provider; and determining whether to pay said provider for said treatment.

### CROSS-REFERENCE TO RELATED APPLICATIONS

This application claims the benefit of Ser. No. 61/116,350, filed Nov. 20, 2008, entitled SYSTEM AND METHOD FOR PROVIDING INSURANCE.

### FIELD

The present invention relates to a system and method for providing medical insurance, and more particularly, to a system and method for providing health insurance related to surgical procedures utilizing implants, prostheses or artificial devices which have both near-term and late-term health-related implications.

### BACKGROUND

Presently, manufacturers' warranties (e.g., Confidence Plus Platinum) and health insurance (e.g., CosmetAssure®) represent the only financial protection available to the breast augmentation patient. As these plans do not cover the most common problems associated with breast augmentation surgery; and are of short duration (30 days for CosmetAssure®), they are not popular with most patients. Further, as they do not compensate the surgeon for professional fees, they are not popular with physicians. Implant surgery, especially breast augmentation, is a unique operation, among most cosmetic surgical procedures. It is unique because of the dynamics of its complication occurrence rate. The occurrence of complications in the breast augmentation patient may be reflected by a bi-modal distribution (two separate peaks plotted over time). Understanding this dynamic is important for any insurance plan to be fiscally solvent.

The first peak is primarily comprised of hematoma/seroma, implant malposition, asymmetry, wound healing problems, size/style change and general dissatisfaction while the second broader peak is made up of primarily capsular contracture, ptosis repair, implant malposition, biopsy and implant leakage/rupture. Again, as current insurance plans and warranties typically do not reimburse the plastic surgeon for his/her services, physicians typically are not motivated to promote the product to their patients.

Patients desire an affordable insurance plan which will truly address their fears of spiraling costs from a succession of complications and re-operations that may be necessary following implant surgery. Women desire a plan which will cover almost every eventuality, near-term and late-term, and at an affordable price. Surgeons desire an insurance plan which will fairly compensate them for their professional services, rather than demand they treat the patient for free.

### SUMMARY

A system and method for providing a health insurance plan designed specifically for the breast augmentation patient is disclosed. With most other plastic or cosmetic operations not utilizing implants (e.g., liposuction) few, if any, complications related to the procedure occur beyond the 30-day post-op window. Thus, there is no need for a long-term insurance policy covering these procedures.

However, such is not the case with the unique situation of implant surgery utilizing breast implants or tissue expanders (as well as, buttock; pectoral; calf; facial; cranial, ophthalmic/ocular, auditory, dental, respiratory, cardiovascular, genitourinary, spinal, gastrointestinal, bariatric, orthopedic, pharmaceutical etc. implants and soft tissue fillers). Here one sees a slowly progressive increase in the incidence of complications with years. The system and method may cover near-term and late-term complications. For device defects such as implant rupture, it may cover those usual and customary fees not provided by the manufacturer's warranty.

The reoperative expense associated with more common early complications (e.g., hematoma/seroma evacuation) is typically much less than the more costly late term complications (i.e., capsular contracture). However, it is the second peak corresponding to late-term complications, which will keep the member committed to the system and method.

### BRIEF DESCRIPTION OF THE DRAWINGS

FIG. 1 is a bi-modal distribution plot over time of the occurrence of complications in a breast augmentation patient.

FIGS. 2A-2F are steps in a method illustrative of the present method.

### DETAILED DESCRIPTION

Each year, over 1 million women world wide seek breast augmentation surgery. One common concern cited by women considering breast augmentation surgery is the fear of costly complications and reoperations. In the United States alone over 380,000 breast augmentation procedures were estimated to have been performed in 2006. Breast augmentation is now the most commonly performed cosmetic operation in the United States. This represents an 868% increase from 1992. With this increase comes an increase in the number of health-related issues associated with breast augmentation, both near-term and late-term.

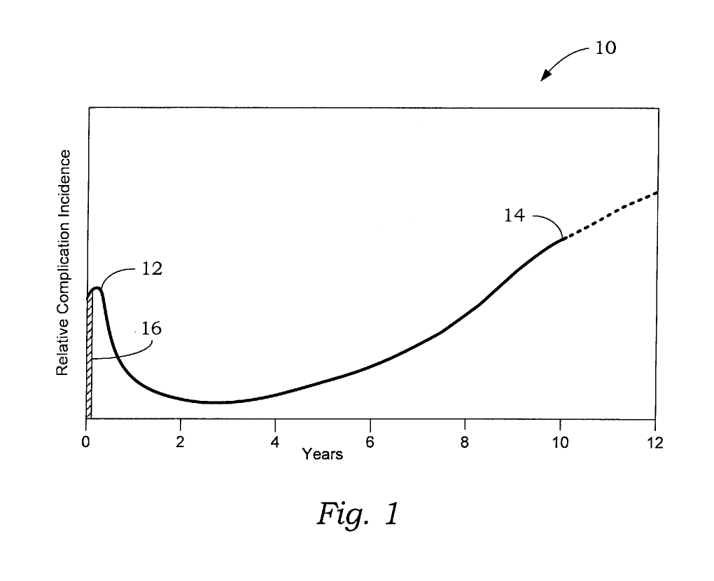

Referring initially to FIG. 1, breast augmentation is a unique operation, among most cosmetic surgical procedures. It is unique because of the dynamics of its complication occurrence rate. Plotted over time, the occurrence of complications in the breast augmentation patient is reflected by a bi-modal distribution 10. Understanding this dynamic is important for any insurance plan to be effective and fiscally solvent.

The first peak 12 is primarily comprised of hematoma/seroma, implant malposition, asymmetry, wound healing problems, size/style change, anaesthesia complications and general dissatisfaction with the results of the procedure, for example. The second broader peak 14 is made up of primarily capsular contracture, ptosis repair and deflation.

The present invention is a system and method for health insurance designed for the breast augmentation patient, but may likewise be applied to cover other operations utilizing implants or prostheses with a similar progressive bi-modal complication occurrence rate. Typically with other cosmetic operations (e.g., liposuction) few, if any complications occur beyond the 30-day post-operative window 16. Thus, an insurance policy that covers complications years after the operation is not practical for the typical cosmetic surgery patient.

However, such is not the case with the unique situation of patients receiving implants, most notably breast augmentation. Here one sees a slowly progressive increase 14 in the incidence of complications over a period of years. The present system and method may cover minor and major complications, which may be predicted by the bi-modal distribution 10. Coverage benefits might include: in-patient hospitalization; ambulance transfer; out-patient surgery; diagnostic imaging and laboratory studies; infection; implant malposition; diagnosis and treatment of deep venous thrombosis, pneumothorax, implant rupture, capsular contracture, adverse reaction, hematoma/seroma, chronic pain, poor wound healing, anaesthetic complications, general unhappiness, etc. Initial evaluation to study implant associated connective tissue, autoimmune, rheumatological disease would potentially be included. Other conditions such as ptosis repair (sagging), biopsy and/or style/size change may also be covered. For a problem related to a device defect such as an implant rupture, the present system and method may cover those usual and customary fees not provided by the manufacturer's warranty. Here the plan may provide coverage after warranty benefits are paid. If the rupture is determined to be iatrogenic by manufacturer's analysis, for example, the plan may pay surgery center and anesthesia fees, and optionally surgeon fees.

The reoperative expense associated with more common early complications (e.g., hematoma/seroma evacuation) is typically much less than the more costly late term complications (i.e., capsular contracture).

Though neither the manufacturer nor the Food and Drug Administration (“FDA”) have published any guidelines recommending routine breast implant replacement, discussions within the FDA advisory panels and the manufacturers strongly suggest a device life expectancy, in vivo, of at least 10 years. Thus, a policy with a term of 4 to 20 years is likewise proposed. Policies covering different types of devices might require different term length and benefits.

Studies have shown a higher complication and reoperation rate within the revision and reconstruction patient populations, than the primary breast augmentation population. Thus different rates may be applied based on these factors. Other factors may include saline versus silicone gel implants. Ideally, enrollment should be completed prior to surgery, with an effective date/time being the induction of anesthesia.

Ideally, all implant surgery should be in accordance with manufacturer's published guidelines and performed by physicians possessing current certification of training, in an accredited or federally certified surgery center or hospital. A grace period may be contemplated allowing enrollment for a limited period of time post-implantation, however, in those cases, the policy may not be retroactive. It may be contemplated that receiving replacement implant(s) during the term of member's policy, may restart the coverage period. Alternatively, the member may continue to be covered under terms of the original policy. A coverage period of less time may occur if (a) both implants are explanted and not replaced; or (b) for nonpayment of premiums. Processing of claims and benefit payments would likely be managed by a third party administrator (TPA).

Typically, surgeon, anesthesia, surgery center, hospital, laboratory and consultant's fees may be paid using conventional code-driven mechanisms and at a regionally adjusted, usual and customary schedule, or percentage thereof. Certain facility/hospital benefit caps or flat rates may also apply.

Premiums may be paid directly by the patient; or alternatively by the surgeon (embedded in the overall cost of surgery); or by the implant manufacturer (possibly embedded in the cost of the implant).

Table 1 below shows the 4-year complication rate by patient for the indicated complications. This table is an example of complications, and specifically for breast implant complications. However, this type of complications table is readily available for other types of implant surgery such as buttock; pectoral; calf; facial; cranial, ophthalmic/ocular, auditory, dental, respiratory, cardiovascular, genitourinary, spinal, gastrointestinal, bariatric, orthopedic, pharmaceutical etc. implants and soft tissue fillers, for example.

TABLE 1
Primary Augmentation: Complications
N = 455

| | 4-Year Complication Rate |
|---|---|
| Complication* | by Patient |
| Reoperation | 23.5% |
| Capsular Contracture III/IV | 13.2% |
| Breast Pain | 8.2% |
| Swelling | 7.8% |
| Implant Removal with Replacement | 7.5% |
| Nipple Complications | 4.9% |
| Implant Malposition | 4.1% |
| Scarring/Hypertrophic Scarring | 3.7% |
| Asymmetry | 3.2% |
| Implant Rupture (MRI cohort)** | 2.7% |
| Implant Removal without Replacement | 2.3% |
| Hematoma | 1.6% |
| Ptosis (sagging) | 1.4% |
| Breast/Skin Sensation Changes | 1.4% |
| Seroma/Fluid Accumulation | 1.3% |
| Bruising, Delayed Wound Heating, | <1% |
| Extrusion of Intact Implant, Implant | |
| Palpability/Visibility, Infection, Redness, | |
| Skin Rash, Tissue/Skin Necrosis, Wrinkling | |
| Capsule Calcification, Irritation, | 0% |
| Lymphadenopathy, Lymphedema, | |
| Other Complications, Pneumothorax | |

Table 2 below provides the main reason for each reoperation performed through four years in primary augmentation patients. The most common reason for reoperation through four years in primary augmentation patients was because of capsular contracture (39 of 135 reoperations).

TABLE 2
Primary Augmentation: Main Reason for Reoperation through
Four Years

| Reason for Reoperation | N |
|---|---|
| Capsular Contracture | 39 |
| Implant Malposition | 21 |
| Ptosis (sagging) | 19 |
| Need for Biopsy | 12 |
| Hematoma/Seroma | 9 |
| Scarring/Hypertrophic Scarring | 8 |
| Patient Request for Style/Size Change | 7 |
| Suspected Rupture | 6 |
| Asymmetry | 5 |
| Delayed Wound Healing | 3 |
| Breast Cancer, Extrusion of Intact Implant, | 1 each |
| Infection, Necrosis, Nipple Complications, | |
| Breast Pain | |
| Total | 135 |

The main reasons for implant removal among primary augmentation patients over the four years are shown in Table 3 below. There were 77 implants removed in 41 patients. Of these 77 implants, 60 were replaced. The most common reason for implant removal was capsular contracture (27 of the 77 implants removed).

TABLE 3
Primary Augmentation: Main Reason for Implant Removal through
Four Years

| Reason for Reoperation | N |
|---|---|
| Capsular Contracture | 27 |
| Patient Request for Style/Size Change | 18 |
| Implant Malposition | 9 |
| Suspected Rupture | 7 |
| Ptosis (sagging) | 6 |
| Asymmetry | 5 |
| Breast Pain | 2 |
| Breast Cancer, Hematoma/Seroma, Extrusion | 1 each |
| of Intact Implant | |
| Total | 77 |

Implant manufacturers are challenged with the task of device tracking and complication monitoring. In the situation of breast implants, data is to be accumulated and submitted for the ongoing FDA post-approval study (silicone only). However, not all patients are enrolling in these studies. Not all physicians are compliant. Patient enrollment in the plan may be preconditioned upon the patient agreeing to conform with post-approval studies and continuing required surveillance/monitoring. This could be assured by (a) eligible health care benefits for significant reportable events would only be paid by the plan, predicated upon proper claim and medical record submission to the plan (and then forwarded to the manufacturer or other monitoring body). Further, (b) a key requirement of the post-approval study is routine MRI evaluations at years three, five, seven and nine. If these studies are paid for by the patient, it may be anticipated that compliance with this critical portion of the study would be low. In one coverage option, the plan would pay for these imaging studies to member patients, and the member would authorize release of results to manufacturer and/or FDA and/or other surveiling body (fee contracting with imaging centers anticipated).

This is a low cost multi-year health insurance plan. It is simple to understand and simple to administer with possibly no co-pays, no deductibles and no limited provider network. Most every eventuality may be covered. Now the patient is no longer going to be angry at the surgeon for suggesting that she owes more fees when an unforeseen complication occurs.

Surgeons may embrace this insurance plan and promote it to their patients because the plan provides for certain benefits to be paid to the surgeon when complications arise. No longer will the surgeon be placed in the sometimes volatile position of informing the patient she owes more money for correction of a complication, of which the surgeon was not responsible. Payments to providers will be made promptly by the plan. However, to remove any inducement to defraud the plan with false claim submission by a few unscrupulous providers, certain checks may need to be instituted: (1) a pre-authorization/predetermination/pre-certification process; (2) claim review; (3) medical record audit on request; (4) coverage limits on professional fees.

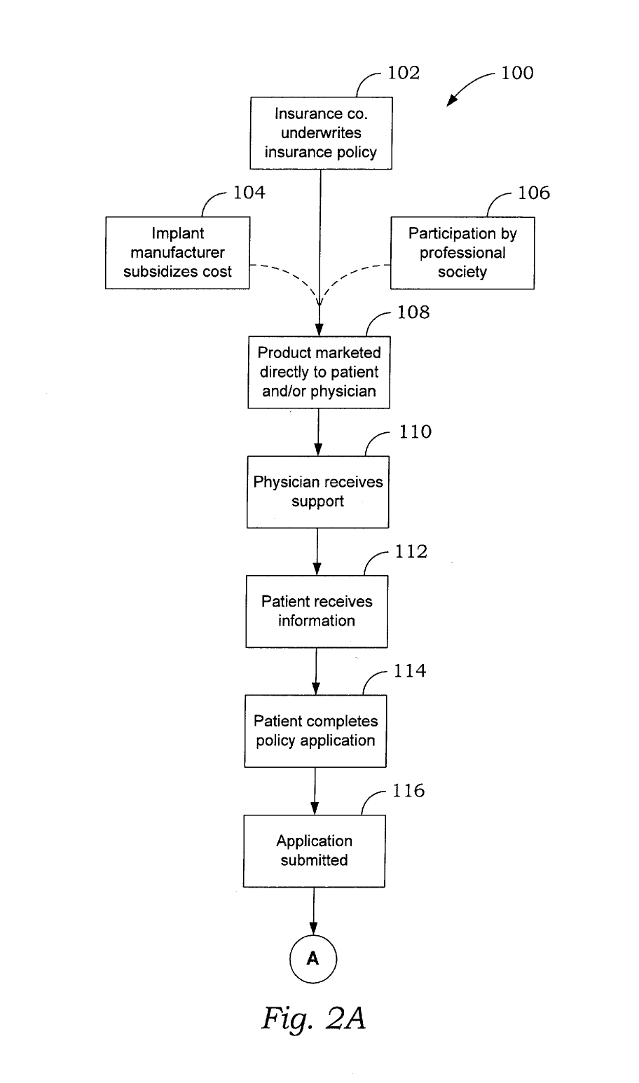

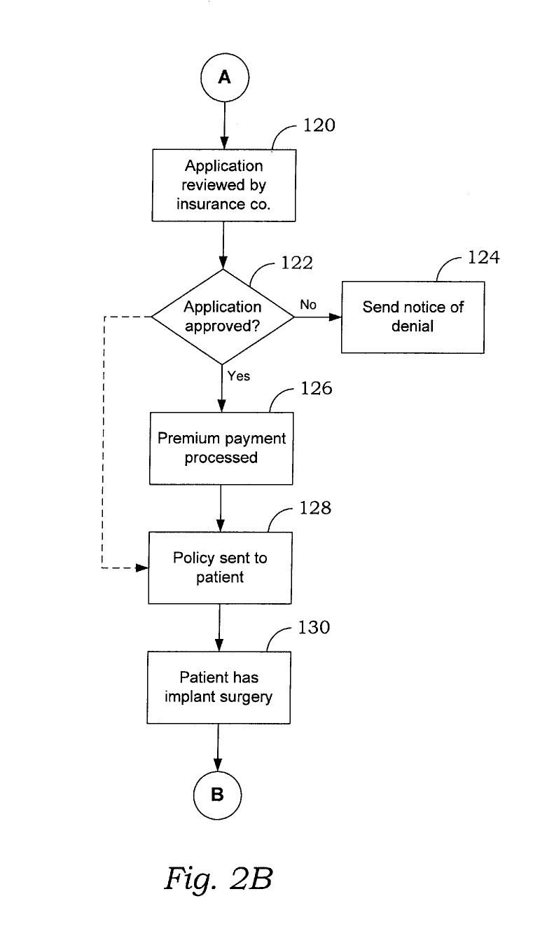

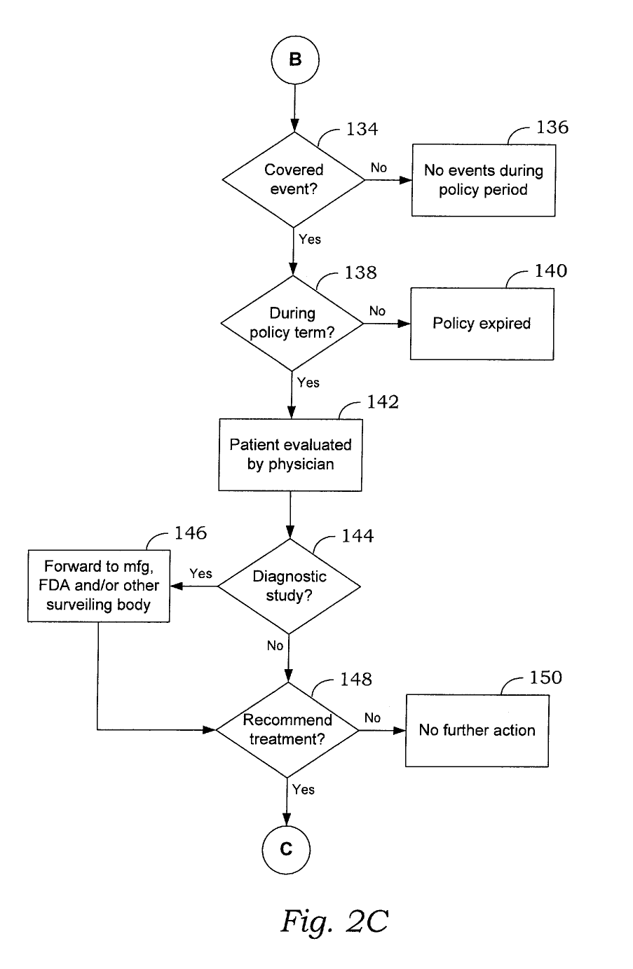

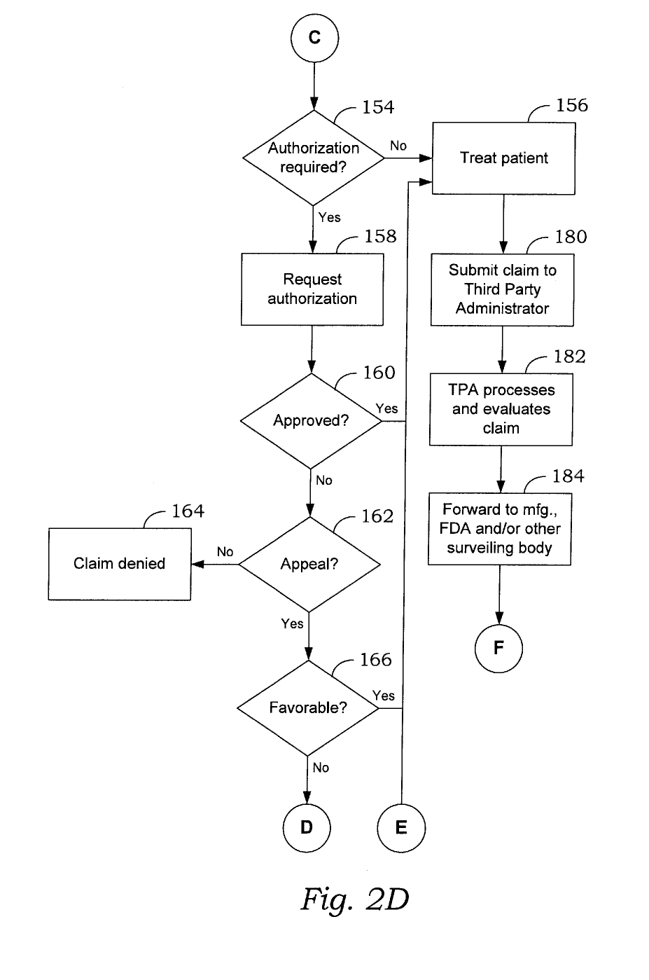

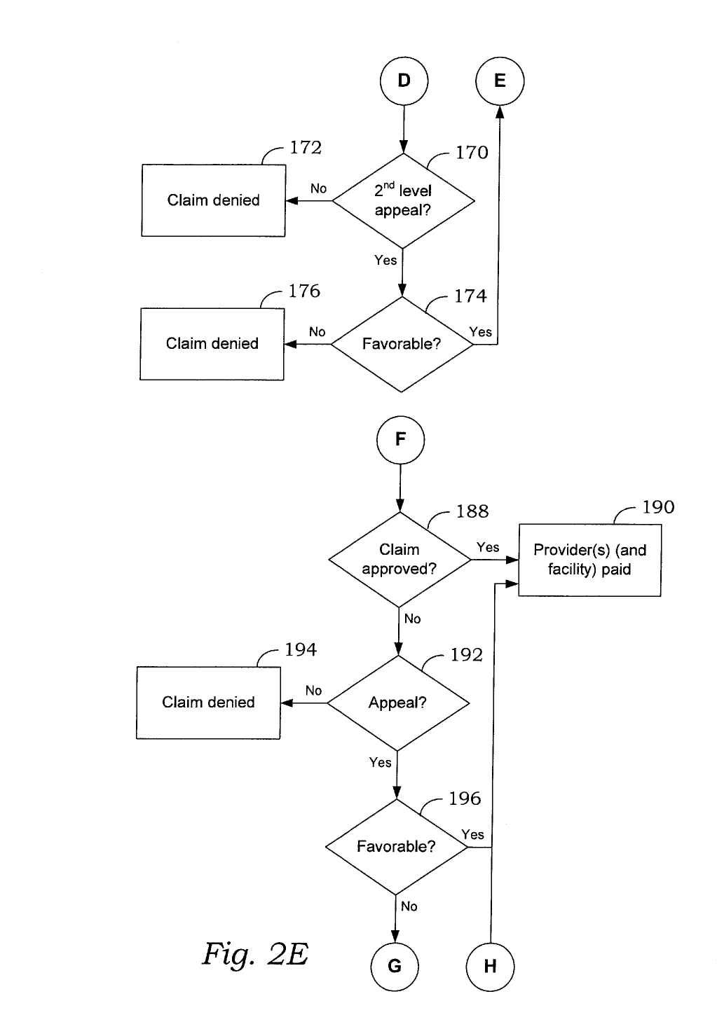

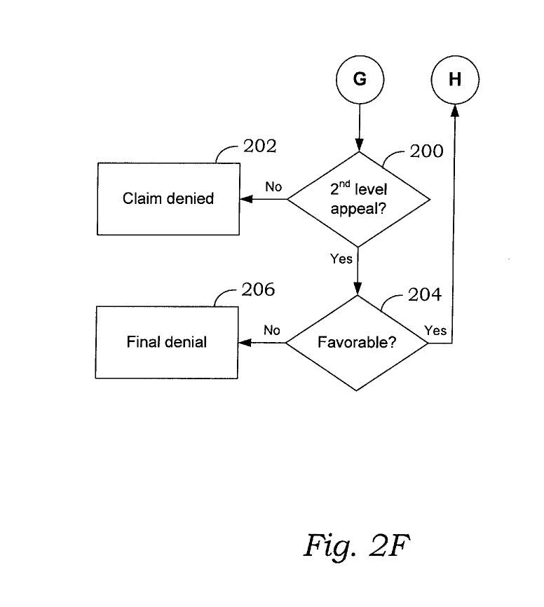

Referring to FIGS. 2A-2F a method of the present invention is generally indicated by reference numeral 100. The process 100 begins with an insurance company underwriting an implant health insurance policy 102. Optionally an implant manufacturer may subsidize the cost 104 and/or a professional medical society may participate in the plan 106. The policy may be marketed directly to the patient receiving the implant and/or the physician performing the surgery 108. The physician may receive support and training on possible marketing, processing of implant health insurance applications and implementation of the policy 110. The patient receives informational materials 112 and if interested completes policy application 114. The completed application is submitted to the insurance company 116.

Next, the application is reviewed by the insurance company 120. If the application is not approved 122, a notice of denial is sent to the applicant 124. If the application is approved 122, a full premium payment (or deposit) is processed by the insurance company 126, unless paid on behalf of the patient by manufacturer or other third party. Optionally, the policy may be automatically issued with the premium paid by the manufacturer. The policy and handbook may be sent to the patient 128. Thereafter, the patient has the implant surgery 130.

If no covered events occur 134, then the policy simply expires 136. If a covered event occurs 134, but it is not during the policy term 138, then no additional action is taken 140. If a covered event occurs 134, during the policy term 138, the patient is evaluated by a physician or surgeon 142. If diagnostic studies are obtained 144, the results may be forwarded to the manufacturer and/or Food and Drug Administration (FDA) or other surveiling body 146. Otherwise, if treatment is not recommended 148, then no further action is taken 150.

If treatment is recommended 148, then authorization is determined per the insurance company's policy and protocol. If no authorization is required 154, then the patient is treated 156. If authorization is required 154, then a request or claim is submitted by the physician to the insurance company or third-party administrator (TPA) for pre-authorization, predetermination and/or pre-certification of surgery 158. If the request is authorized 160, the patient is treated 156. If authorization is denied 160, then the patient may appeal 160. If no appeal is timely filed, then the claim is finally denied 164. If the denial is appealed 162, and the review by the TPA or other reviewer is favorable 166, the patient is treated 156. If the appeal is not favorable 166, a second level appeal may be submitted 170.

If the second level appeal 170 is not requested, then the claim is finally denied 172. If the second level appeal is requested, and the review is favorable 174, the patient is treated 156. If not, the claim is finally denied 176.

If the patient is treated 156 according to the recommendations of the physician or surgeon, code-driven claim(s) may be submitted by the provider(s) and facility to the TPA 180, which may include supporting records. The TPA processes and evaluates the claim 182 and forwards the reportable event data to the implant manufacturer, FDA and/or other surveiling body 184. If the TPA approves the claim 188, the provider is paid in accordance with the policy terms and benefits 190. If the claim is denied by the TPA 188, the patient or provider may appeal the claim denial 192. If no appeal is submitted then the claim is finally denied 194. If the claim is appealed 192 and the review is favorable 196, then the provider is paid 190. If the review is not favorable 196, a second level appeal may be submitted 200. If no second level appeal is filed, then the claim is finally denied 202. If the review of the second level appeal is favorable 204, then the provider is paid 190. If the review is not favorable 204, then the claim is finally denied 206.

It is to be understood that while certain now preferred forms of this invention have been illustrated and described, it is not limited thereto except insofar as such limitations are included in the following claims.

1. A method of providing post-operative insurance including the steps of:
underwriting an insurance policy for a medical procedure;
offering said insurance policy to a patient undergoing said medical procedure;
receiving an application for said insurance policy from said patient;
approving said application for said insurance policy from said patient;
performing said medical procedure on said patient;
receiving a policy claim for an event;
evaluating said policy claim to determine if said event is a covered event;
denying said policy claim if said event is not a covered event or if said policy has expired; and
if said event is a covered event,
recommending a treatment;
treating said patient by a provider; and
determining whether to pay said provider for said treatment.

2. The method of claim 1 wherein said underwriting step includes participation by a professional medical organization.

3. The method of claim 1 wherein said medical procedure includes an implant.

4. The method of claim 3 wherein said underwriting step includes participation by a manufacturer of said implant.

5. The method of claim 1 wherein said offering step includes providing information to said patient.

6. The method of claim 1 wherein said approving step includes sending said insurance policy to said patient.

7. The method of claim 1 wherein said recommending step includes evaluating said patient by a physician.

8. The method of claim 1 wherein said recommending step includes forwarding event information to a third party.

9. The method of claim 1 wherein said recommending step includes recommending no treatment.

10. The method of claim 1 wherein said recommending step includes requesting authorization for a recommended treatment.

11. The method of claim 10 wherein said requesting authorization step is denied.

12. The method of claim 10 wherein said requesting authorization step is approved.

13. The method of claim 1 wherein said paying step includes submitting a medical claim to an administrator.

14. The method of claim 13 wherein said submitting step includes processing and evaluating said medical claim.

15. The method of claim 14 wherein said processing and evaluating step includes submitting information regarding said medical claim to said third party.

16. The method of claim 14 wherein said processing and evaluating step includes determining if said medical claim is approved, wherein if said medical claim is approved paying said provider for said medical procedure, and wherein if said medical claim is not approved, denying payment to said provider for said medical procedure.

17. A method of providing post-operative insurance including the steps of:
underwriting an insurance policy for a medical procedure including an implantable device;
providing said insurance policy to a patient undergoing said medical procedure; and
performing said medical procedure on said patient.

18. The method of claim 17 further including the steps of receiving a policy claim for an event;
evaluating said policy claim to determine if said event is a covered event;
denying said policy claim if said event is not a covered event or if said policy has expired; and
if said event is a covered event,
recommending a treatment;
treating said patient by a provider; and
determining whether to pay said provider for said treatment.

19. The method of claim 17 wherein said underwriting step includes participation by a professional medical organization.

20. The method of claim 17 wherein said underwriting step includes participation by a manufacturer of said implantable device.

21. The method of claim 17 wherein said providing step includes offering information to said patient.

22. The method of claim 17 wherein said providing step includes sending said insurance policy to said patient.

23. The method of claim 18 wherein said recommending step includes evaluating said patient by a physician.

24. The method of claim 18 wherein said recommending step includes forwarding event information to a third party.

25. The method of claim 18 wherein said recommending step includes recommending no treatment.

26. The method of claim 18 wherein said recommending step includes requesting authorization for a recommended treatment.

27. The method of claim 26 wherein said requesting authorization step is denied.

28. The method of claim 26 wherein said requesting authorization step is approved.

29. The method of claim 18 wherein said paying step includes submitting a medical claim to an administrator.

30. The method of claim 29 wherein said submitting step includes processing and evaluating said medical claim.

31. The method of claim 30 wherein said processing and evaluating step includes submitting information regarding said medical claim to said third party.

32. The method of claim 30 wherein said processing and evaluating step includes determining if said medical claim is approved, wherein if said medical claim is approved paying said provider for said medical procedure, and wherein if said medical claim is not approved, denying payment to said provider for said medical procedure.
